(19) United States
(12) Patent Application Publication
(10) Pub. No.: US 2004/0073459 A1
(43) Pub. Date: Apr. 15, 2004

(54) Bio-surveillance system and method

(75) Inventor: Edward N. Barthell, Mequon, WI (US)

Correspondence Address: Timothy E. Newholm, BOYLE, FREDRICKSON, NEWHOLM, STEIN & GRATZ, S.C., 250 Plaza, Suite 1030, 250 East Wisconsin Avenue, Milwaukee, WI, 53202, US

(73) Assignee: Infinity Healthcare

(21) Appl. No.: 10/649,127

(22) Filed: Aug. 27, 2003

Related U.S. Application Data
(60) Provisional application No. 60/418,104, filed on Oct. 11, 2002.

(51) Int. Cl. G06F 17/60

(52) U.S. Cl. 705/2

(57) ABSTRACT

A method and apparatus of detecting a bio-emergency, including receiving patient health information at a plurality of health care facilities. The patient health information, preferably triage data, is transmitted simultaneously with the receiving step to a bio-surveillance network for pooling and further analysis. In particular, the patient health information is then compiled to create, for example, volumetric health data. The information preferably is transmitted over a multi-level network including a number of local health care facilities such as hospital emergency rooms, a number of regional repositories such as regional health departments, and a centralized recipient such as the CDC. The local health care facilities communicate vertically with the regional repositories that, in turn, communicate vertically with the centralized recipient and possibly horizontally with other regional repositories. The centralized recipient can then transmit related information such as a health warning to the other members of the network and/or to other authorities.

### CROSS REFERENCE TO RELATED APPLICATION

This application claims priority under 35 U.S.C. §119(e) to U.S. Provisional Patent Application No. 60/418,104, filed Oct. 11, 2002, the subject matter of which is hereby incorporated herein by reference in its entirety.

### BACKGROUND OF THE INVENTION

1. Field of the Invention

The present invention is directed to a method and system for compiling patient health data obtained by a plurality of health care providers, and more particularly, to an Internet-based system and method that communicate patient health data to a bio-surveillance network in real-time so as to facilitate early detection and warning of a bio-emergency.

2. Description of Related Art

Recent events have caused an increased sense of urgency with regard to implementing an effective bio-surveillance system. Unfortunately, shortcomings in, for example, hospital emergency department record-taking limit the capacity to answer many fundamental, clinical, epidemiological and health service utilization questions regarding emergency patients. As a result, and in view of large volumes of patients and the shift work approach to staffing, emergency departments are vulnerable to situations where insidious problems emerge but are not recognized or reported. Presently, no effective system has been deployed on a widespread basis to collect and analyze population-based emergency encounter data, notwithstanding that it is widely acknowledged that the potential of such a system to improve public health is significant.

In the past, surveillance efforts in emergency medicine have used convenience sampling and retrospective review of records at a small number of health care facilities, with limited results available only months after the data collection has actually occurred. More recent efforts have been employed to provide syndromic surveillance on a “drop-in” basis in the setting of a high-risk event such as political conventions or the 2002 winter Olympics in Salt Lake City, Utah. Nevertheless, systematic real-time data collection and pooling of bio-surveillance data captured at remote locations during routine care at emergency departments is not readily available.

A number of agencies have also initiated a variety of more traditional programs for medical surveillance, in particular with regard to surveillance of injuries and infectious diseases. However, problems with such systems include limited data, including for example, fatal injuries statistics but none for morbidity, limitations associated with sampling techniques, and other related drawbacks. In addition, there are problems associated with collecting, transmitting, and compiling data in a useful manner. Data transmission is often delayed, up to three years for some systems. The transmitted data is also often incomplete and/or not in an easily compilable or analyzable form. The data is also not consistently and timely delivered to centralized authorities best able to detect and react to a bio-emergency, such as the Centers for Disease Control (CDC). Moreover, current data transmission processes include mailing paper-based reports and bulletins and labor-intensive phone calls between public health offices and clinicians, with the resultant communication hampered by time delays and lost, incomplete, or misinterpreted messages. All in all, some known systems provide significant advances in the use of technology for bio-surveillance, but most are limited in scope, and all of them lack real-time collection, analysis and the reporting capability required to achieve concurrent feedback to providers at the time of emergency patient care. In sum, timely, meaningful communication between public health officers and emergency clinicians remains problematic.

Any bio-surveillance system and method attempting to address the needs addressed above will face a number of challenges. These include the challenge to obtain data from providers concurrent with care processes in the intense environment of emergency medicine. As a result, a system that is both helpful and relatively unobtrusive to the health care providers is desired. The project must overcome the challenge of bringing together otherwise competing institutions with the goal of supporting public health initiatives. It will be challenged to use standards-based systems that can be distributed on a secure, yet cost-effective way over the public Internet.

As a result, the field of bio-surveillance systems is in need of a system that operates to provide systematic, real-time, population-based data collection and pooling of bio-surveillance data. Preferably, the data should be provided to a network concurrently with care processes to minimize the chance that health care facility personnel become overburdened in the intense environment of emergency medicine. In this regard, the bio-surveillance data should be captured during routine care at regional emergency health departments such that the system and method operate without requiring additional resources during execution. Moreover, such a system should generate data according to accepted standards to insure that the information is capable of widespread deployment via built or existing infrastructure. To permit effective bio-surveillance, the data should be transmitted and even compiled in real-time from hospitals to regional repositories such as state health departments and from the regional repositories to a central authority such as the CDC.

### SUMMARY OF THE INVENTION

The preferred embodiment is directed to a medical surveillance system and method that operates to collect patient health information from, for example, emergency departments which act as “sensors.” A processing center receives the collected data in real-time, preferably via the Internet, and analyzes the collected information to determine trends and to determine whether action is needed in the interest of public health. If so, the system communicates the information back to emergency health care providers or regional repositories to allow the recipients to adapt to evolving conditions. The information can also be related to other authorities such as law enforcement authorities and/or the civil defense. Preferably, all of the information conveyed within the system is standardized for inter-operability with current medical record software and network capabilities.

According to a first aspect of the preferred embodiment, a method of detecting a bio-emergency includes receiving patient health information at a plurality of health care facilities. The patient health information, preferably triage data, is transmitted simultaneously with the receiving step to a bio-surveillance network for pooling and further analysis. In particular, the patient health information may then compiled to create, for example, volumetric health data. In another aspect of this preferred embodiment, the bio-surveillance network includes at least one regional repository, i.e., each of which communicates directly with at least one of the health care facilities and a centralized recipient. More preferably, the system includes a plurality of regional repositories.

According to another aspect of this embodiment, the method includes comparing the compiled health data to a threshold. The method thereafter includes generating a warning signal in response to the comparing step if the threshold is exceeded. In addition, the method includes communicating the warning signal to at least one of a group including the health care facilities, a law enforcement agency, a health department, and a hospital network. Preferably, the warning signal is communicated automatically in response to the comparing step.

According to another aspect of the preferred embodiment, a method of detecting a bio-emergency includes receiving triage patient health information at a plurality of health care facilities and communicating the triage patient health information to a regional depository. Then, the method includes compiling the triage patient health information to generate volumetric triage data (VTD), and comparing the volumetric triage data with a predetermined threshold. If the threshold is exceeded, a warning signal is generated and thereafter transmitted for use by intended recipients.

In another aspect of the preferred embodiment, a bio-surveillance system includes a bio-surveillance network. The system includes a user interface disposed at a health care facility. The user interface is adapted to collect triage information relating to a patient and communicates the patient triage information automatically, and in real-time, to the bio-surveillance network.

According to a yet another aspect of the preferred embodiment, a method of bio-surveillance includes collecting patient triage data at a health care facility, and transmitting the patient triage data automatically and in real-time to a bio-surveillance network. The method includes detecting a bio-emergency based on the patient triage data, and generating a warning corresponding to the bio-emergency.

According to an alternate aspect of this embodiment, the detecting step includes comparing the patient triage data to a threshold. In addition, the method includes communicating the warning to the health care facility to facilitate patient diagnosis.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a block diagram of a bio-surveillance detection and alert network according to a preferred embodiment;

FIG. 2 is a flow chart illustrating a process of collecting and transmitting bio-surveillance data within a network to identify and communicate a bio-emergency to appropriate locations; and

FIGS. 3 and 4 are screen prints generated during a data collection step of a preferred embodiment of the bio-surveillance process.

### DETAILED DESCRIPTION OF THE PREFERRED EMBODIMENTS

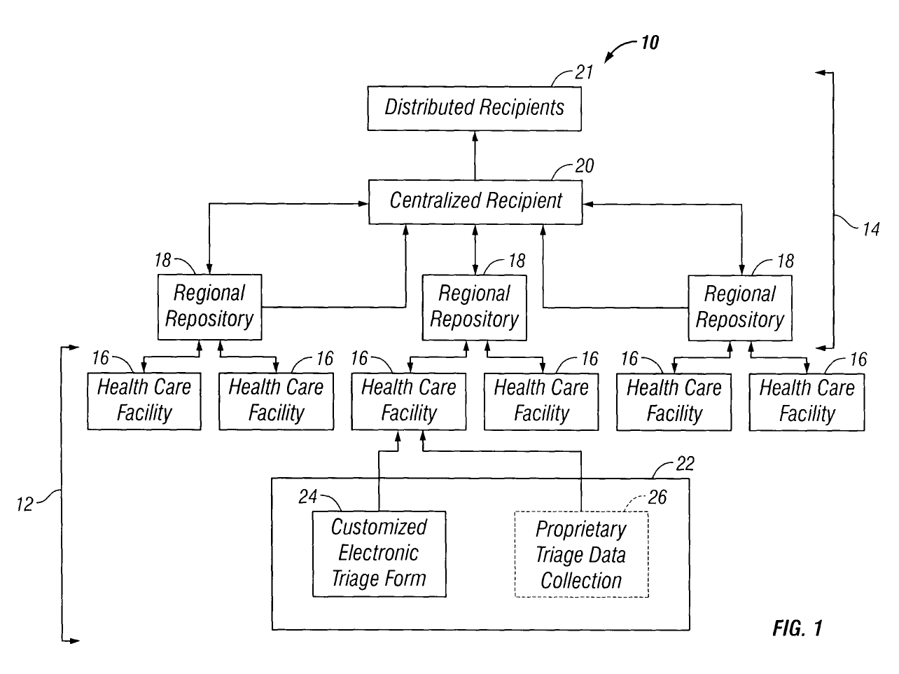

Referring to FIG. 1, a Web-based medical surveillance system 10 includes an intake sub-system 12 and a bio-surveillance network 14. Intake sub-system 12 operates to gather patient health information, for example, at a number of health care facilities 16, such as hospitals, and then communicate the health information to a bio-surveillance network 14 to determine whether a bio-emergency condition may exist. In particular, the information is collected by one or more health care facilities 16 and communicated to, preferably, a collection of associated regional repositories 18 that compile the information for further downstream communication and analysis. For example, each regional repository 18 may be a regional health department such as a local health department serving a city or county, a state health department serving a state, or a multi jurisdictional health department serving a major multi-state metropolitan area or a particular region of a country. Notably, emergency departments of health care providers 16 are uniquely positioned as sites for surveillance and data collection as they are open twenty-four hours a day, are ubiquitous in distribution, and treat patients from all ethnic and socioeconomic classes. They are also the “frontlines” that are the first to see and treat critically ill patients.

The information compiled by the regional repositories 18 can be communicated to other regional repositories 18 and/or to a centralized recipient 20 for farther analysis. By analyzing the compiled data from regional repositories 18, the centralized recipient 20 can determine whether a health warning should be issued. Alternatively, data analyzation may be conducted at the regional repositories themselves. A comparison between a threshold level for a particular condition or conditions and the compiled data may be made, and if the threshold is exceeded, a health warning may be generated. The centralized recipient may, for example, be the Centers for Disease Control (CDC). It may also be a regional or state health department receiving information from regional repositories in the form of state and/or local health departments or similar organizations. In this case, the centralized recipient may additionally communicate “horizontally” with similarly situated recipients and/or “vertically” or up-the-latter with an even-more centralized recipient. For example, if the regional repositories 18 are local health departments and the centralized recipient 20 is a state health department, the centralized recipient may communicate horizontally with other state health departments and vertically to the CDC, hence completing a four-level architecture as opposed to the three-level architecture illustrated in FIG. 1. The health warning generated by the centralized recipient 20 may thereafter be communicated to locations adapted to utilize the information essentially in real-time. For example, the information may be communicated directly back to the regional repositories 18 and/or back to the health care facilities 16 themselves to facilitate diagnosis. The information may also be further communicated to the public. In this case, the health warning may be communicated to distributed recipients 21, such as a law enforcement agency that can coordinate notifying the public, or a hospital network that can notify specific health care providers that an emergency situation, for example, an outbreak, is occurring.

### System Set-Up

With more particular reference to intake sub-system 12, a triage tool including a user interface 22 and application software may be installed at each health care facility 16, preferably, in combination with existing or installed portable or desktop personal computers configured for uploading data to the Internet. In some cases, the health care facilities 16 will already be linked with an existing surveillance network. For those limited cases in which the health care facility is already linked, an independent user interface is not required.

For cases in which the health care facility 16 is not linked to an existing surveillance network, complaints reported at triage typically are entered into the current hospital registration system as text based non-codified reason for the visit. Advantageously, once triage is completed via user interface 22, a paper record can be generated.

Such a system is exemplary of the majority of current emergency departments. Therefore, although configured in an open-ended format, the preferred implementation of the system employs an electronic triage form 24 that is customized for implementation at health care facilities 16 of system 10.

As an alternative, proprietary triage data collection forms 26 may be used. These forms may, for example, be ones that interface via a protocol known in the field as HL7. Forms of this type are currently installed on the intake networks of some existing health care facilities, may be used. In either case, by maintaining flexibility with respect to using either the customized electronic triage form 24 or proprietary software 26 during triage, a stated goal of the National Electronic Disease Surveillance System (NEDSS) project of the CDC is met, namely, the facilitation of the transmission of standardized clinical data. As a result, widespread deployment of system 10 can be readily realized.

System operation is based on accepted and emerging data and messaging standards wherever possible. This will include mapping of the triage data elements to both the CDC sponsored Data Elements for Emergency Department Systems (DEEDS) and the International Classification of Disease (ICD) codes, as well as reporting in a format consistent with the CDCP's National Center for Health Statistics. As HL7 Version 3.0 continues to emerge, it is anticipated that surveillance report standards will be mapped as a clinical data document within the overall HL7 architecture. Prior to installing system 10, medical coding personnel may perform a base line analysis of medical and billing records from a subset of the health care facilities 16 to determine the frequency of the triage complaint data, as opposed to final diagnosis data, and thereafter assign an appropriate ICD code for eventual use during bio-surveillance system operation. The same personnel typically will also examine records after implementation of system 10 to measure the frequency with which the system enables accurate real-time capture of codified complaint data from the triage process.

The preferred embodiment of system 10 is based on application of extensible mark up language (XML) to the Data Elements for Emergency Department Systems (DEEDS) standard promulgated by CDC. Moreover, network 14 can be readily interfaced with currently available surveillance systems. For example, the clinical data may be integrated with the National Electronic Disease Surveillance System (NEDSS), which may define at least some portion of network 14.

Overall, network 14 defines an Extranet communications framework based on emerging Web technologies, including appropriate security architecture, to provide a reliable, high quality, cost-efficient architecture for standardized data exchange. In this regard, the security environment provides appropriate safeguards and maintains patient confidentiality consistent with National Research Council (NRC), and Health Insurance Portability and Accountability Act (HIPAA), and NUT recommendations. Preferably, commercially available hardware and software components, available, e.g., from CartaNova of Mequon, Wis., are installed on end user PCs to provide contextual security and user authentication, as controlled by an ASP-based regional security server. Moreover, regional repositories store collected triage information and convey that information to the centralized recipient in a manner that allows a base level of reporting to support real-time emergency surveillance by public health officials. In particular, a standardized set of Web-based summary and exception reports from the collected triage information for presentation to researchers and public health authorities. The system also preferably implements a mechanism for public health authorities and medical researchers to conduct ad hoc analysis of the data beyond the standardized reports. In addition, a Web-based geographic information system viewer which allows for flexible data reporting using a commercially available tool set, such as the one provided by ESRI of Redlands, Calif., is provided. As part of the regional repository set-up, areas of priority are identified for developing and implementing additional data collection and reporting modules onto the network system for widespread deployment.

In sum, the security architecture and integration of unique security protocols and technology ensure identification and authentication of users, as well as origin of transactions. Preferably, the architecture includes a unique wireless proximity and security, contextual based, identification and authentication device (not shown) for end users. Also, system 10 has the ability to display frequencies, distribution, patterns, and influencing agents, associated with the migration of syndromes of concern using a dynamic Web-based viewer integrated with a geographic information system (not shown).

### System Operation

The user interface 22 of the triage tool, whether it employs triage form 24 or proprietary triage data collection form 26, is used by nurses or triage technicians to record data as a routine part of the emergency care intake process. In general, the user interface 22 will prompt the triage personnel to enter structured data through, preferably, drop-down menus to encourage entry of data that can then be matched automatically to appropriate 1CD codes through system logic. Upon completion of the triage record, the staff can print a hard copy of the triage data for inclusion in a permanent medical record. Software, such as the CartaNova CDA system, may be used for security and user access control, as noted previously.

In the preferred embodiment, the information is received at a triage location of intake sub-system 12 at the corresponding health care facility 16 upon initial interface between the patient and with health care staff. Hospital staff enters the information. Once entered, the information is communicated directly (i.e., automatically and in real-time) to, for example, the corresponding regional repository 18 without any additional action required by the hospital triage staff. As a result, the transfer of information from health care facilities 16 to the network 14 is preferably entirely transparent to hospital staff.

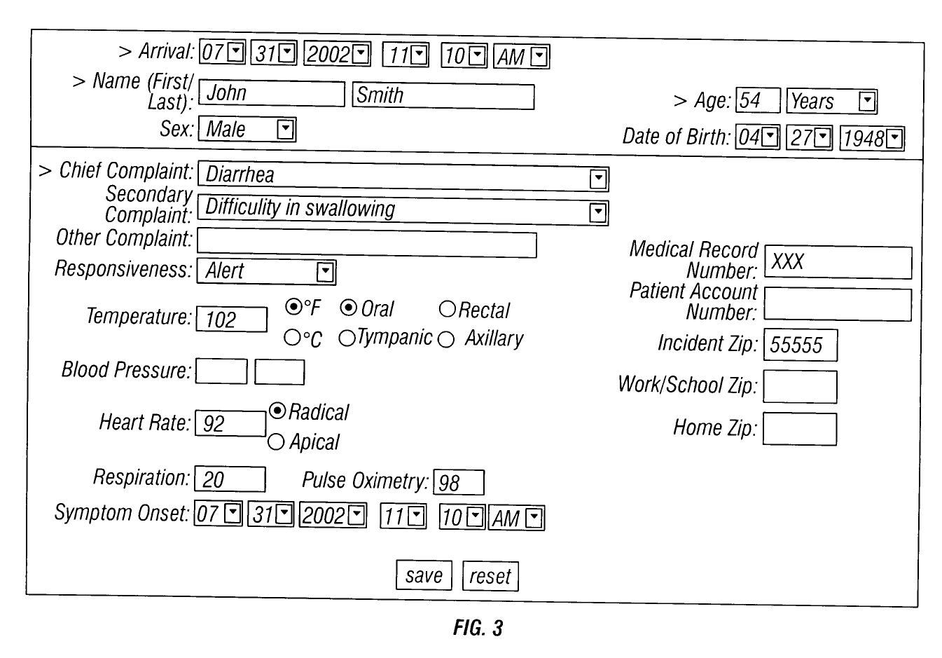

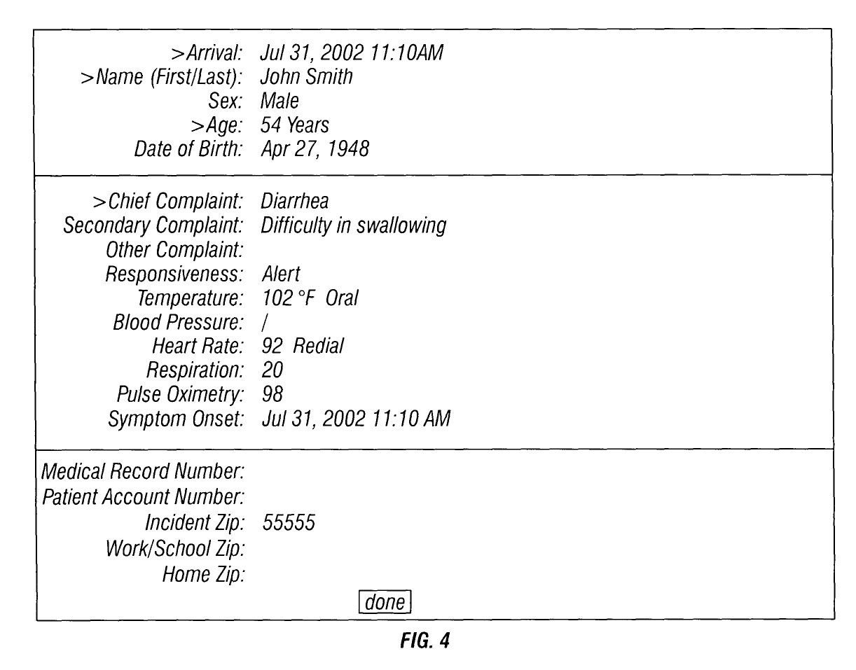

With respect to the type of data being entered at triage stations at health care locations 16, typical data may consist of a primary complaint, such as difficulty breathing, as well as secondary complaints, including associated symptoms, such as dizziness or fever. Moreover, additional data elements to be collected pertain to profiles of individual patients including the age and sex, vital signs, level of consciousness and zip codes of home, work and incident site. Of course, this is only a sampling of the information that may be obtained at triage. This information may be entered using an electronic form such as the one illustrated in FIG. 3. A computerized confirmation of the transmission of the data collection in that form may be generated and displayed as illustrated by the screen print of FIG. 4.

There are two primary types of health related data which may be communicated within network 14 of system 10, data relating to symptoms and data relating to syndromes. The two types of health data are not mutually exclusive, as syndrome data typically is compiled based on patient symptoms recorded at triage. In the first case, raw data entered by the health care facility personnel may be directly communicated without modification to network 14. The data is thereafter compiled and analyzed to determine whether a health warning condition is met. Notably, the data collected at the triage units of the health care facilities 16 may be translated into a code associated with a number of categories of compliance, as partially shown immediately below in Table 1.

TABLE 1
SYMPTOM HIERARCHIAL LIST

| Acute Injuries | | Respiratory Problems | |
|---|---|---|---|
| 959.3 | Injury to elbow, forearm, or wrist | 514 | Chest congestion |
| 921.9 | Injuryto eye | 786.2 | Cough |
| 959.09 | Injury to face or neck | 786.3 | Hemoptysis |
| . | | . | |
| . | | . | |
| . | | . | |
| Pain (without acute injury) | | Foreign Bodies | |
| 789.00 | Pain, abdominal | 931 | Foreign body, ear |
| 724.5 | Pain, back | 930.8 | Foreign body, eye |
| 786.50 | Pain, chest | 932 | Foreign body, nose |
| . | | . | |
| . | | . | |
| . | | . | |

| | |
|---|---|
| etc. | etc. |

Alternatively, the triage tool may be adapted to process the triage data to create data associated with resultant syndromes. Exemplary syndrome data may be connected with the following complaints: shortness of breath, diarrhea, rash, fever, altered mental status, confusion, a coma or loss of consciousness, facial muscle weakness (including visual or swallowing difficulties, dropping eyelids, slurred speech and dry mouth), and toxic chemical inhalation or other toxic exposure. In this case, the data may be conveyed according to stratification by age (i.e., pediatric, adult age 18-65, and geriatric age groups), respiratory rate, and pulse oximetry readings, for example.

Proper training of triage personnel can result in a great percentage of encounters being assigned one or more of approximately 60-70 possible codified chief complaints. The chief complaints may, in some embodiments, be expanded to about 140 complaints to provide additional granularity. To ensure that credible evidence is gathered, the following issues are emphasized. First, response time measures will be performed to document the time spent capturing the data. Automated performance tools are employed to measure internal system speeds, etc. Next, flexibility is key. The system preferably is configured to permit additional data fields to be added to it so that the system is able to evolve. In addition, data quality is ensured by conducting retrospective systematic reviews of specific emergency encounters, such as by reviewing billing reports to determine baseline frequency of cases that have ICD codes assigned to reflect presenting complaints of the patient.

Next, upon receipt of data from the individual health care facilities, sensitivity is monitored at the regional depository and/or centralized recipient level by monitoring baseline frequency and variability for each of the complaints. Once the baseline frequencies are determined, sensitivity for detecting significant changes from this baseline can be determined. In this process, both cluster analysis techniques and time series analyses, such as autocorrelation correlograms, or autoregressive moving average modeling is employed. In addition, determining the proportion of reported cases that actually have the related health event under surveillance is particularly important when symptoms are used for syndromic surveillance that is used to predict specific problems, such as bio-terrorism. This key factor and system implementation are known as “predictive value positive.”

The next key factor is directed to representativeness. In particular, the data to be analyzed includes patients of all ages, both sexes and all racial and ethnic minority populations in various regions, to provide broad-based representation. Timeliness is important, as a key aspect of the preferred embodiment is its real-time nature of health care data communication. Finally, stability and scalability are also maintained.

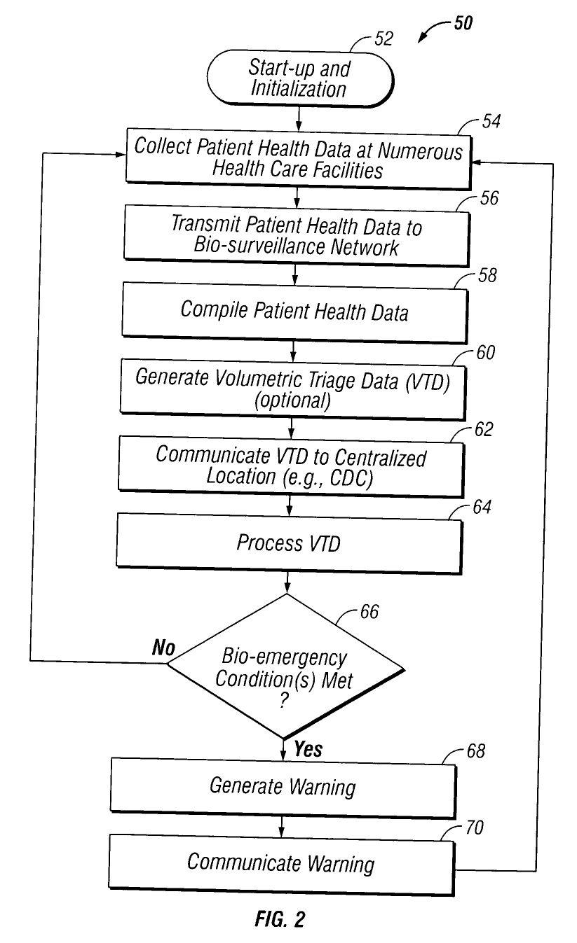

Turning next to FIG. 2, a method of real-time bio-surveillance that utilize the protocols described above is directed to a process 50 having a start up and initialization Block 52 after which the user (e.g., health care facility staff) asks the patient a series of questions to collect appropriate data in Block 54. For example, this step may be preformed at a triage unit of each of a number of health care facilities 16, such as hospitals shown in FIG. 1. Next, in Block 56, upon entry in the health care facilities systems, the health information is transmitted in real-time to corresponding regional repositories 18 of the bio-surveillance network (14 in FIG. 1) such as state health departments as described previously. Thereafter, in Block 58, the data is compiled, preferably at the regional repositories 18. This transmission is transparent to the person collecting and entering the data. In Block 60, the data may be processed into volumetric data, such as Volumetric Triage Data (VTD) for further communication and analysis. In this regard, the volumetric data is then communicated, in Block 62, to a centralized recipient in Block 60 for further analysis.

In Block 64, process 50 analyzes the volumetric data then determines whether the volumetric data indicates a bio-emergency in Block 66. In this regard, for instance, the CDC has identified six primary bio-terrorism threats, termed Type “A” threats, including anthrax, small pox, plague, botulism, tularemia and hemorrhagic fevers. If a bio-emergency is determined to be high risk, a health warning signal is generated in Block 68.

The corresponding warning signal may be communicated to law enforcement agencies, back to the state or regional health departments, hospital networks, etc. in Block 70. Moreover, the data may be displayed and communicated geographically according to dynamic parameters entered, for example, at triage. A public health reporting tool may be implemented at this point. The reporting tool is preferably capable of communicating a combination of standardized summary and exception reports, as well as ad hoc reports. For example, analysis of the collected data may indicate an average of the cases per day with a primary complaint of diarrhea. The reporting tool can operate to automatically notify a public health authority if the number of cases exceeds a predesignated threshold.

On the other hand, if a particular threshold is not exceeded such that a bio-emergency is determined not to be “high risk,” the process 50 returns to Block 54 to continuously collect additional data from the health care facilities (16 in FIG. 1) in the network. In any event, preferably, the process is implemented continuously to monitor potential outbreaks and other bio-emergencies 24 hours a day.

Notably, whether a bio-emergency is detected or not, the data may be communicated back to the health care facilities 16 to be used during diagnosis. Moreover, when a patient is discharged, additional data may be collected at intake subsystem 12 and communicated back to network 14 in real-time for compilation and further analysis to continuously monitor the potential of a bio-emergency.

### EXAMPLE

A non-limiting example of the manner in which the process method of the preferred embodiment is implemented is described. First, as a member of the health care personnel (e.g., a nurse) approaches a computer terminal in the triage bay of a hospital emergency room or similar institution, the individual enables the data entry process by, e.g., pressing a button on a contextual digital assistant (CDA). In response, system 10 responds by prompting the user to respond to a challenge question presented on the computer terminal by the CDA. The challenge questions are programmed into the CDA when that CDA is assigned to preferably, the challenge question is one that the user knows the answer to, and will never forget, and is unknown to others. Of course, the CDA can hold several questions and answers, which are presented to the user in a random order each time they use the computer terminal, which provides a further level of security. As a result, the culmination of an individually registered CDA and a valid time period, are employed to automatically initiate the computerized triage system.

Next, the CDA provides wireless communication to nearby workstations. In this case, the CDA authenticates the user, generates an encrypted password that is communicated to the workstation, and the user is granted immediate access to the computerized triage system. Once in the system, the user can conduct the triage process with the incoming patient according to typical procedure. Again, as described previously, this may include using a Web-based triage form. As soon as a triage record is saved the encountered information is sent as an encrypted standardized XML based message over the Internet to the regional repositories, for example. The Web service authenticates the user as an authorized user of the system. The service also recognizes the possibility that the information may be relevant to an on-going research study at the user's workplace for patients with this type of chief complaint. In this case, the Web service sends a message back to the user's workstation to remind the user to obtain consent for the patient to be entered into the study. Finally, the Web service forwards the encountered data to the regional repository. The regional repository dynamically adds the encounter to the patterns of encounters streaming from multiple health care facilities 16 in the region serviced by the repository.

Alternatively, if a patient being triaged becomes unstable and is transferred immediately to the critical care area, for example, the user typically will be unable to complete the form on the triage bay workstation. In this case, the user can, for instance, switch to a mobile wireless PC in the emergency department and complete the computerized data collection form at bedside, again using the CDA for secure access control. As before, upon completing the triage form, the user saves the record, and the pertinent data from the record is automatically transmitted to the regional repository in real-time.

After using the system, the user may walk away from the workstation without performing any log-off activities. Due to constant polling between the wireless receiver on the workstation and the user's CDA, when the user steps away from the system it goes into pause mode masking the information on the screen and securing the application. If the user does not return to the terminal within the, for example, established 5-minute time out, the user is automatically logged off. If other users wish to interface with the workstation when it is in pause mode, those users must simply press the activation button on their CDA to log the initial user off and gain their own secure access.

Next, a local public health officer may wish to view patterns of chief complaints in an area and therefore logs onto a workstation with the officer's CDA badge. For example, a dashboard display appears, and with a selection of parameters of interest, the display shows a geographic display of the chief complaint of interest over a predetermined time period. For example, the display may indicate a higher than normal incidence of acute blood diarrhea originating from a specific zip code. As a result, the local public health officer sends a message to the triage displays, i.e., user interfaces 22 in FIG. 1, in the region. Thereafter, when additional patients are triaged with this complaint, the system automatically prompts the local public health officer and other triage personnel so that patients presenting with this complaint can be queried for more specific history about recent exposures. Although data which is compiled at the regional repositories (18 in FIG. 1) may be analyzed at the repositories, the data is more preferably transmitted to a centralized recipient, such as the CDC, as described previously. Upon analysis, an appropriate warning may be generated and issued for mass communication and/or individual diagnosis at the health care facilities (16 in FIG. 1).

Of course, this is simply an example to illustrate the preferred embodiment, and the flexibility of system 10 and method 50 allow for a wide range of applications.

In addition to the preferred embodiments described above, the implementation of system 10 may result in multiple other commercial and societal benefits. While recent events have caused significant focus on the need for effective surveillance for insidious bio-terrorism acts, surveillance system 10 can also be used to detect clusters of other emergency injury and disease patterns. For example, drug research studies can be managed over the same information architecture. Moreover, alerts and educational information could be distributed to caregivers in an effort to improve quality and care and reduce medical errors, and system 10 can provide a backbone and development pathway for creation of a comprehensive population based real-time surveillance and intervention system derived from the national emergency departments.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

What is claimed is:

1. A method of detecting a bio-emergency, the method comprising:
receiving patient health information at a plurality of health care facilities; and
transmitting, simultaneously with said receiving step, the patient health information to a bio-surveillance network; and
compiling the patient health information to create compiled health data.

2. The method of claim 1, wherein the bio-surveillance network includes at least one regional repository that communicates directly with at least one of the health care facilities.

3. The method of claim 2, wherein the regional repository is a regional health department.

4. The method of claim 2, wherein the at least one regional repository includes a plurality of regional repositories.

5. The method of claim 4, wherein said compiling step is performed at the regional repositories.

6. The method of claim 5, further comprising communicating the compiled health data to at least one group including the regional repositories and a centralized recipient.

7. The method of claim 5, wherein the bio-surveillance network includes a centralized recipient that receives the compiled health care data from at least one of the regional repositories.

8. The method of claim 7, further comprising comparing the compiled health data to a threshold.

9. The method of claim 8, further comprising generating a warning signal in response to said comparing step.

10. The method of claim 9, further comprising communicating the warning signal to at least one of a group including the health care facilities, a law enforcement agency, a health department, and a hospital network.

11. The method of claim 10, wherein the step of communicating the warning signal is performed automatically in response to said comparing step.

12. The method of claim 7, wherein the centralized recipient is the Centers for Disease Control (CDC).

13. The method of claim 1, wherein the patient health information includes triage information.

14. The method of claim 13, wherein the triage information includes symptom information.

15. The method of claim 14, wherein the triage information includes a primary complaint.

16. The method of claim 15, wherein the triage information includes a secondary complaint.

17. The method of claim 14, further comprising categorizing the symptom information.

18. The method of claim 1, wherein said categorizing step includes generating syndromic data.

19. The method of claim 1, wherein said receiving step is performed using proprietary software.

20. The method of claim 1, wherein said transmitting step is implemented via the Internet.

21. A method of detecting a bio-emergency, the method comprising:
receiving individual triage patient health information at a plurality of health care facilities from each of a plurality of patients;
on a patient-by-patient basis, electronically recording triage data for that patient in a computer of the associated health care facility, the triage data for each patient containing at least some of the received health information for that patient;
upon recording the triage data for each patient, transmitting at least a portion of the recorded triage data to a computer for one of a plurality of regional repositories automatically and in at least near real-time, the computer for each of the regional repositories receiving triage data from a computer for each of a plurality of the health care facilities;
transmitting triage data to a computer for a centralized recipient from the computers for regional repositories automatically and in at least near real time with its receipt from the computers for the health care facilities;
analyzing the triage data and determining, based on the analysis, whether a possible bio-emergency exists;
communicating, from the centralized recipient, information regarding the possible bio-emergency to at least one or more of the regional repositories, one or more health care facilities, and other institutions having an interest in responding to a possible bio-emergency.

22. The method as recited in claim 21, further comprising
compiling the triage data for individual patients to generate volumetric triage data (VTD);
comparing the volumetric triage data with a predetermined threshold; and transmitting a warning in response to said comparing step.

23. The method as recited in claim 22, wherein the compiling step is performed by the computer for the regional repositories, and the comparing step is performed by the computer for the centralized recipient.

24. A method of compiling medical information;
receiving individual patient health information at a plurality of health care facilities from each of a plurality of patients;
on a patient-by-patient basis, electronically recording data for that patient in a computer for the associated health care facility, the data for each patient containing at least some of the received health information for that patient;
upon recording the data for each patient, transmitting at least a portion of the recorded data to a computer for one of a plurality of regional repositories automatically in at least near real-time, the computer for each of the regional repositories receiving triage data from a plurality of the health care facilities; and
transmitting data to a computer for a centralized recipient from the computers for the regional repositories, the data being derived from or comprising the data received from computers for the health care facilities and being transmitted automatically and in at least near real-time with its receipt from the health care facilities.

25. The method as recited in claim 24, wherein the data is triage data obtained upon initial examination of each patient, and further comprising:
analyzing the triage data and determining, based on the analysis, whether a possible bio-emergency exists,
communicating, from the centralized recipient, information regarding the possible bio-emergency to at least one of one or more of the regional repositories, one or more of the health care facilities, and other institutions having an interest in responding to a possible bio-emergency.

26. The method as recited in claim 24, wherein the data is syndromic data, and further comprising using computers for at least one of the regional repositories and the centralized recipient, compiling the syndromic data, and disseminating information regarding the compiled syndromic data.
